(19) United States
(12) Patent Application Publication
(10) Pub. No.: US 2007/0013178 A1
(43) Pub. Date: Jan. 18, 2007

(54) Inflatable curtain with fill tube and quick connect coupling for optional third row curtain

(75) Inventor: Jeffrey S. Aird, Rochester, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 11/182,650

(22) Filed: Jul. 15, 2005

(51) Int. Cl. B60R 21/213; B60R 21/26

(52) U.S. Cl. 280/740; 280/730.2; 280/742

(57) ABSTRACT

An apparatus (10) helps protect an occupant of a vehicle (12). The apparatus (10) includes a first inflatable vehicle occupant protection device (50) and a first fill tube (82) for delivering inflation fluid to the first inflatable vehicle occupant protection device. The first inflatable vehicle occupant protection device (50) is inflatable to protect occupants of a first row (40) of vehicle seating. The apparatus (10) also includes a second inflatable vehicle occupant protection device (60) and a second fill tube (100) for delivering inflation fluid to the second inflatable vehicle occupant protection device. The second inflatable vehicle occupant protection device (60) is inflatable to protect an occupant of a row (42, 44) of vehicle seating different than the first row (40) of vehicle seating. The apparatus (10) further includes a quick connect coupling (150) for connecting the second fill tube (100) to the first fill tube (82) to direct inflation fluid from the first fill tube into the second fill tube.

### FIELD OF THE INVENTION

The present invention relates to an inflatable apparatus for helping to protect a vehicle occupant in the event of a side impact to the vehicle and/or a vehicle rollover.

### BACKGROUND OF THE INVENTION

It is known to inflate an inflatable vehicle occupant protection device to help protect a vehicle occupant. One particular type of inflatable vehicle occupant protection device is an inflatable curtain. The inflatable curtain is inflatable away from the roof of the vehicle between a vehicle occupant and the side structure of the vehicle in response to a side impact to the vehicle and/or a vehicle rollover. A known inflatable curtain is inflated from a deflated condition with inflation fluid directed from an inflator to the inflatable curtain.

### SUMMARY OF THE INVENTION

The present invention relates to an apparatus for helping to protect an occupant of a vehicle. The apparatus includes a first inflatable vehicle occupant protection device and a first fill tube for delivering inflation fluid to the first inflatable vehicle occupant protection device. The first inflatable vehicle occupant protection device is inflatable to protect occupants of a first row of vehicle seating. The apparatus also includes a second inflatable vehicle occupant protection device and a second fill tube for delivering inflation fluid to the second inflatable vehicle occupant protection device. The second inflatable vehicle occupant protection device is inflatable to protect an occupant of a row of vehicle seating different than the first row of vehicle seating. The apparatus further includes a quick connect coupling for connecting the second fill tube to the first fill tube to direct inflation fluid from the first fill tube into the second fill tube.

The present invention also relates to an apparatus for helping to protect an occupant of a vehicle that has first row seating and second row seating. The apparatus includes a first inflatable vehicle occupant protection device and a first fill tube for delivering inflation fluid to the first inflatable vehicle occupant protection device. The first inflatable vehicle occupant protection device is inflatable to protect occupants of the first row seating. The apparatus also includes a second inflatable vehicle occupant protection device and a second fill tube for delivering inflation fluid to the second inflatable vehicle occupant protection device. The second inflatable vehicle occupant protection device is inflatable to protect occupants of the second row seating. The apparatus further includes a quick connect coupling secured to the first fill tube. The quick connect coupling receives a second fill tube and provides fluid communication between the first and second fill tubes. The quick connect coupling includes locking means operable to connect the second fill tube to the first fill tube when the second fill tube is received in the quick connect coupling. The quick connect coupling also includes valve means openable upon the second fill tube being received in the quick connect coupling. The valve means when opened provides fluid communication between the first and second fill tubes.

The present invention further relates to an apparatus for helping to protect an occupant of a vehicle that has first row seating, second row seating, and third row seating. The apparatus includes a first inflatable vehicle occupant protection device and a first fill tube for delivering inflation fluid to the first inflatable vehicle occupant protection device. The first inflatable vehicle occupant protection device is inflatable to protect occupants of the first row seating and the second row seating. The apparatus also includes a second inflatable vehicle occupant protection device and a second fill tube for delivering inflation fluid to the second inflatable vehicle occupant protection device. The second inflatable vehicle occupant protection device is inflatable to protect an occupant of the third row seating. The apparatus further includes a quick connect coupling for connecting the second fill tube to the first fill tube to direct inflation fluid from the first fill tube into the second fill tube.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic side view of an apparatus for helping to protect a vehicle occupant illustrating the apparatus in a deflated and stored condition in the vehicle, according to a first embodiment of the invention;

FIG. 2 is a schematic side view of the apparatus of FIG. 1 in the inflated condition;

FIG. 3 is an exploded schematic view, partially in section, of a portion of the apparatus of FIGS. 1 and 2;

FIG. 3A is a schematic view of a portion of the apparatus of FIG. 3;

FIGS. 4-5 are schematic views, partially in section, illustrating the assembly of the portion of the apparatus of FIG. 3;

FIG. 6 is a schematic side view of an apparatus for helping to protect a vehicle occupant illustrating the apparatus in a deflated and stored condition in the vehicle, according to a second embodiment of the invention; and

FIG. 7 is a schematic side view of the apparatus of FIG. 6 in the inflated condition.

### DESCRIPTION OF EMBODIMENTS

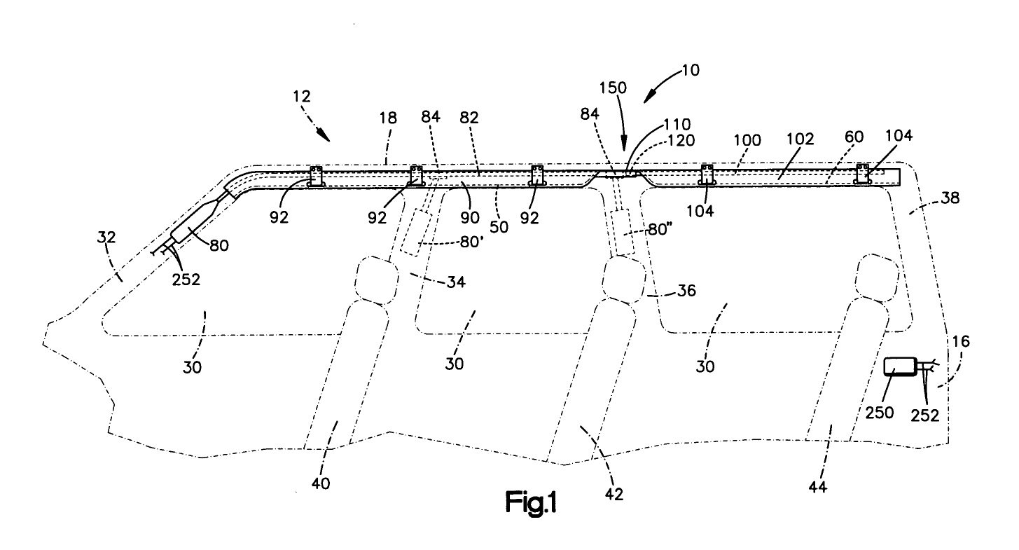

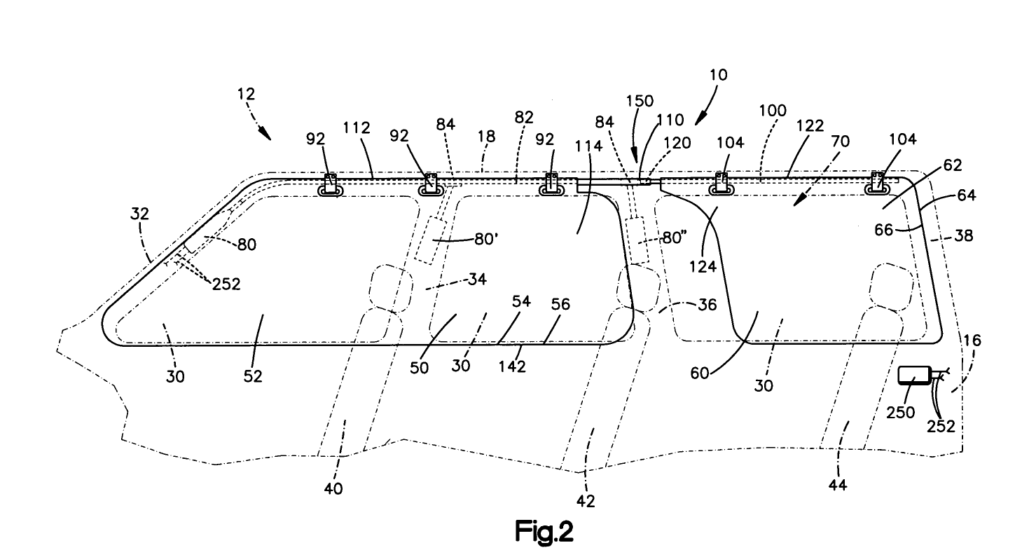

Representative of the present invention, an apparatus 10 helps to protect an occupant (not shown) of a vehicle 12. As shown in FIGS. 1 and 2, the vehicle 12 includes a side structure 16 and a roof 18. The side structure 16 of the vehicle 12 includes side windows 30, an A pillar 32, a B pillar 34, a C pillar 36, and a D pillar 38. The vehicle 12 also includes first row seating 40, second row seating 42, and third row seating 44. The third row seating 44 may be optional vehicle equipment. For example, the vehicle 12 may be one in which the space between the C pillar 36 and D pillar 38 is normally a cargo space. In this instance, the third row seating 44 may be offered as optional vehicle equipment to provide increased seating capacity in the vehicle 12.

The apparatus 10 includes a first inflatable vehicle occupant protection device in the form of a first inflatable curtain 50 and a second inflatable vehicle occupant protection device in the form of a second inflatable curtain 60. The inflatable curtains 50 and 60 are mounted adjacent the roof 18 of the vehicle 12. The first inflatable curtain 50 is provided to help protect occupants of the first row seating 40 and second row seating 42. The second inflatable curtain 60 is provided to help protect occupants of the third row seating 44.

The first inflatable curtain 50 includes panels 52 (FIG. 2) of material that are arranged in an overlying manner. The panels 52 are interconnected along at least a portion of a perimeter 54 of the first inflatable curtain 50 to form a perimeter connection 56 of the curtain. The perimeter connection 56 helps define an inflatable volume of the first inflatable curtain 50. The first inflatable curtain 50 may also include connections (not shown) within the perimeter 54 that form non-inflatable portions of the curtain. These non-inflatable portions may help define inflatable chambers of the first inflatable curtain 50. These connections may also help divide the inflatable volume of the first inflatable curtain 50 into two or more separate inflatable volumes that are isolated from each other.

The second inflatable curtain 60 includes panels 62 of material that are arranged in an overlying manner. The panels 62 are interconnected along at least a portion of a perimeter 64 of the first inflatable curtain 60 to form a perimeter connection 66 of the curtain. The perimeter connection 66 helps define an inflatable volume of the second inflatable curtain 60. The second inflatable curtain 60 may also include connections (not shown) within the perimeter 64 that form non-inflatable portions of the curtain. These non-inflatable portions may help define inflatable chambers of the second inflatable curtain 60. These connections may also help divide the inflatable volume of the second inflatable curtain 60 into two or more separate inflatable volumes that are isolated from each other.

The first and second inflatable curtains 50 and 60 may be formed in a variety of manners, such as by weaving the overlying panels of each curtain as a single piece of material, by stitching the panels together, or by interconnecting the panels via ultrasonic welding, heat bonding, or adhesives. In a one piece woven construction, the overlying panels 52 and 62 may be woven simultaneously from a material, such as nylon yarn, and may be coated with a gas impermeable material, such as urethane, or laminated with a gas impermeable film. The inflatable curtains 50 and 60 thus may have a substantially gas-tight construction. Those skilled in the art will appreciate that alternative materials, such as polyester yarn, and alternatives coatings, such as silicone, may also be used to construct the inflatable curtains 50 and 60.

The apparatus 10 includes an inflation fluid source in the form of an inflator 80 that is connected in fluid communication with the first inflatable curtain 50 through a first fill tube 82. The first fill tube 82 may be constructed of any suitable material, such as metal or plastic. In the illustrated embodiment, the first fill tube 82 extends along the length of the first inflatable curtain 50, i.e., above the first row seating 40 and second row seating 42.

As shown in FIGS. 1 and 2, the inflator 80 may be mounted at a location, such as the A pillar 32 of the vehicle 12, and connected to a terminal end of the first fill tube 82 at or near the A pillar. Alternatively, as shown in dashed lines, the inflator 80 could be mounted to the B pillar 34, as shown at 80′, or to the C pillar 36, as shown at 80″. In these instances, the inflator 80 could be connected to the fill tube 82 via a fitting 84, such as a “T” fitting. In this case, the first fill tube 82 may comprise two separate lengths of tube connected to the fitting 84 or the first fill tube could be constructed as a single tube with an integral fitting. As a further alternative, the inflator 80 could be mounted to the vehicle 12 at a location (not shown) adjacent the intersection of the side structure 16 and roof 18, such as a roof rail of the vehicle 12.

The inflator 80 contains a stored quantity of pressurized inflation fluid (not shown) in the form of a gas. The inflator 80 alternatively could contain a combination of pressurized inflation fluid and ignitable material for heating the inflation fluid, or could be a pyrotechnic inflator that uses the combustion of gas-generating material to generate inflation fluid. As a further alternative, the inflator 80 could be of any suitable type or construction for supplying an inflation medium.

The apparatus 10 may also include a housing 90 (FIG. 1) that houses the first inflatable curtain 50 in a stored and deflated condition. The first fill tube 82, the deflated first inflatable curtain 50, and the housing 90 have an elongated configuration and extend along the vehicle roof 18 and along the side structure 16 above the side windows 30 adjacent the first and second row seating 40 and 42. The first fill tube 82, first inflatable curtain 50 and housing 90 are connected to the vehicle 12 by known means 92, such as brackets.

The apparatus 10 also includes a second fill tube 100 for directing inflation fluid into the second inflatable curtain 60. The second fill tube 100 may be constructed of any suitable material, such as metal or plastic. In the illustrated embodiment, the second fill tube 100 extends along the length of the second inflatable curtain 60, i.e., above the third row seating 44.

The apparatus 10 may also include a housing 102 (FIG. 1) that houses the second inflatable curtain 60 in a stored and deflated condition. The second fill tube 100, the deflated second inflatable curtain 60, and the housing 102 have an elongated configuration and extend along the vehicle roof 18 and along the side structure 16 above the side windows 30 adjacent the third row seating 44. The second fill tube 100, second inflatable curtain 60 and housing 102 are connected to the vehicle 12 by known means 104, such as brackets.

The second fill tube 100 is connected to the first fill tube 82 so as to provide fluid communication between the tubes. Inflation fluid may thus be directed from the first fill tube 82 into the second fill tube 100 to inflate the second inflatable curtain 60. As shown in FIGS. 1 and 2, an end portion 110 of the first fill tube 82 is connected to an end portion 120 of the second fill tube 100. The first fill tube 82 protrudes from the first inflatable curtain 50 adjacent or near an upper edge 112 and a rear portion 114 of the first inflatable curtain. The end portion 120 of the second fill tube 100 protrudes from the second inflatable curtain 60 adjacent or near an upper edge 122 and front portion 124 of the second inflatable curtain.

According to the present invention, the connection between the first and second fill tubes 82 and 100 is established through the use of a quick connect coupling 150. The quick connect coupling 150 facilitates a mechanical interlock between the first and second fill tubes 82 and 100 that is established by urging together mating components of the coupling. There is no need to use separate fastening means, such as fasteners, clamps, welding, or separate connection tubes to interconnect the first and second fill tubes 82 and 100. Also, there is no need to use separate means, such as stitching, ultrasonic welding, adhesives, or heat bonding to connect the first and second inflatable curtains 50 and 60.

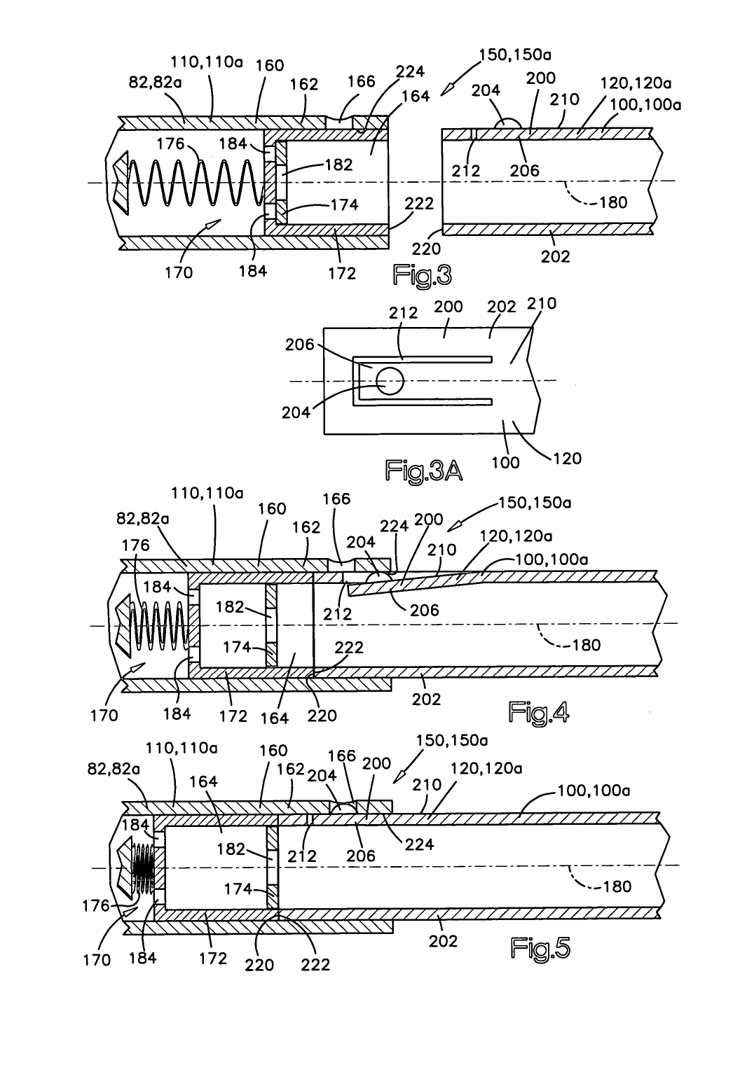

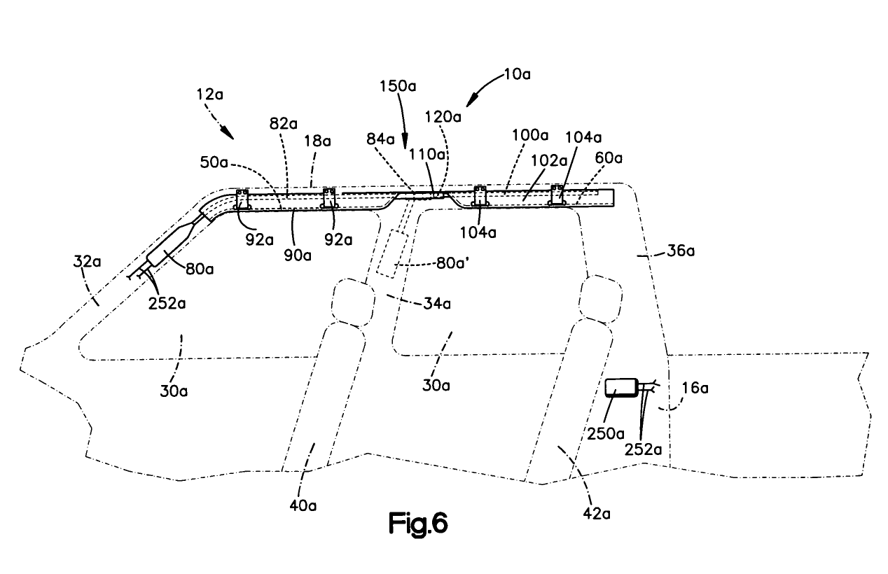

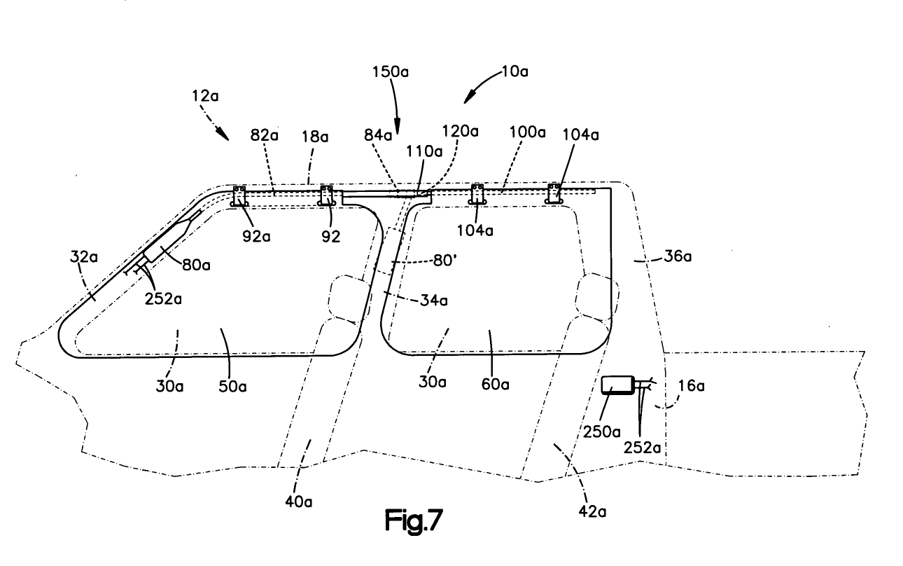

The quick connect coupling 150 is shown in greater detail in FIGS. 3-5. As described below, FIGS. 3-5 are also illustrative of a quick connect coupling 150a of a second embodiment of the invention, shown in FIGS. 6 and 7 and described below. In the following description of FIGS. 3-5, the quick connect coupling is described as applying to the embodiment of FIGS. 1 and 2. Those skilled in the art, however, will appreciate that the following description of the quick connect coupling applies to the embodiment of FIGS. 6 and 7.

The quick connect coupling 150 includes a first coupling portion 160 associated with the end portion 110 of the first fill tube 82. The first coupling portion 160 includes a sleeve portion 162 that defines a chamber 164. The first coupling portion 160 also includes a latch member receiving portion 166 in the form of an opening extending through the sleeve portion 162. The latch member receiving portion 166 could have an alternative configuration, such as a recess that extends into the sleeve portion 162 without extending through the sleeve portion.

In the illustrated embodiment, the coupling portion 160 and sleeve portion 162 have a generally cylindrical configuration. The coupling portion 160 and sleeve portion 162 could, however, have alternative configurations, such one having a polygonal cross-section. Also, in the illustrated embodiment, the sleeve portion 162 is formed integrally, i.e., as one piece, with the end portion 110 of the first fill tube 50. The sleeve portion 162 could, however, be formed as a piece separate from the first fill tube 50 and connected to the first fill tube by means, such as welding, press fitting, mechanical coupling, or bonding.

The quick connect coupling 150 also includes valve means which, in the embodiment of FIGS. 3-5, comprises a valve assembly 170 disposed in the chamber 164 of the sleeve portion 162. The valve assembly 170 shown in FIGS. 3-5 is but one particular example configuration that may be implemented in the quick connect coupling 150. Those skilled in the art will appreciate that the valve assembly 170 may have any known configuration.

In FIGS. 3-5, the valve assembly 170 is shown schematically. The valve assembly 170 includes a stop member 172 that is biased against a seat member 174 by a biasing member 176, such as a spring. The stop member 172 is slidable in the sleeve portion 162 along an axis 180. The seat member 174 is secured to the sleeve portion 162 by means (not shown) such as welding. For example, the seat member 174 may be welded to the sleeve portion 162 at radial locations on the sleeve portion not shown in FIGS. 3-5. In this configuration, the stop member 172 may include longitudinal slots (not shown) for providing a clearance between the stop member and the welds between the seat member 174 and sleeve portion 162.

The seat member 174 includes a central opening 182. The stop member 172 includes one or more openings 184 spaced about the stop member outside the diameter of the central opening 182. The biasing member 176 biases the stop member 172 along the axis 180, in a direction to the right as viewed in FIGS. 3-5, against the seat member 174. In this condition, fluid communication between the central opening 182 and the openings 184 is blocked. The valve assembly 170 may include means (not shown), such as an O-ring, for helping to form seal between the stop member 172 and the seat member 174.

The quick connect coupling 150 also includes a second coupling portion 200 associated with the end portion 120 of the second fill tube 100. The second coupling portion 200 includes a sleeve portion 202 that has an outside diameter about equal to an inside diameter of the sleeve portion 162 of the first coupling portion 160. The second coupling portion 200 is thus insertable into the chamber 164 of the first coupling portion 160.

The second coupling portion 200 also includes a latch member 204 formed on a tab portion 206 of the sleeve portion 202. The latch member 204 has a generally spherical or domed configuration and projects from an outer surface 210 of the sleeve portion 202. The tab portion 206 is defined by a slot 212 that extends through the sleeve portion 202. As shown in FIG. 3A, the slot 212 has a generally U-shaped configuration with the legs of the U extending lengthwise along the sleeve portion 202 to form the tab portion 206 as a single piece of material with the sleeve portion 202. The tab portion 206 could, however, be formed as a separate piece of material that is connected to the sleeve portion 202. The tab portion 206 is bendable or deflectable relative to the remainder of the sleeve portion 202.

In the illustrated embodiment, the coupling portion 200 and sleeve portion 202 have a generally cylindrical configuration similar to, but having a smaller diameter than, the coupling portion 160 and sleeve portion 162. The coupling portion 202 and sleeve portion 162 could, however, have alternative configurations, such one having a polygonal cross-section. Also, in the illustrated embodiment, the sleeve portion 202 is formed integrally, i.e., as one piece, with the end portion 120 of the second fill tube 100. The sleeve portion 202 could, however, be formed as a piece separate from the second fill tube 100 and connected to the second fill tube 100 by means, such as welding, press fitting, mechanical coupling, or bonding.

The quick connect coupling 150 connects the second fill tube 100 to the first fill tube 82. To do this, the fill tubes 82 and 100 are positioned such that the first and second coupling portions 160 and 200 are aligned with each other along the axis 180. This is shown in FIG. 3. The coupling portions 160 and 200 are moved toward each other along the axis 180 such that the sleeve portion 202 enters the sleeve portion 162.

As the sleeve portion 202 enters the sleeve portion 162, the latch member 204 engages the sleeve portion 162. This is shown in FIG. 4. When this occurs, the latch member 204 acts as a cam and rides on an inner surface 224 of the sleeve portion 162, which causes the tab portion 206 to deflect toward the axis 180, as shown in FIG. 4. The tab portion 206 may be deflected manually, such as by pressing on the latch member 204, to help facilitate inserting of the sleeve portion 202 in the sleeve portion 162.

Upon further movement of the sleeve portion 202 along the axis 180, the latch member 204 reaches the opening 166 in the sleeve portion 162. The latch member 204 is urged into the opening 166 under the resilience of the tab portion 206. This is shown in FIG. 5. The latch member 204, when positioned in the opening 166, helps block the sleeve portion 202 from being removed from the sleeve portion 162. The coupling portions 160 and 200, and the first and second fill tubes 82 and 100, are thus connected to each other. From the above, those skilled in the art will appreciate that the quick connect coupling 150 includes locking means which, in the embodiment of FIGS. 3-5, comprises the sleeve portions 162 and 202, latch member 204, tab portion 206, and opening 166.

Connecting the coupling portions 160 and 200 also actuates the valve assembly 170 to an open condition, which establishes fluid communication between the first and second fill tubes 82 and 100. As the sleeve portion 202 enters the sleeve portion 162, a terminal end surface 220 of the sleeve portion 202 engages a terminal end surface 222 of the stop member 172. As the sleeve portion 202 is inserted into the sleeve member 162, the stop member 172 is urged to move against the bias of the biasing member 176, i.e., to the left as viewed in FIGS. 3-5. As the stop member moves against the bias of the spring, fluid communication is established between the central opening 182 of the seat member 174 and the openings 184 of the stop member 172. This establishes fluid communication between the first and second fill tubes 82 and 100.

The first and second fill tubes 82 and 100 may be connected to each other in the manner described above after the first fill tube, along with the first inflatable curtain 50, inflator 80, and housing 90 are installed in the vehicle 12. The second fill tube 100 may be connected to the first fill tube while the second fill tube, second inflatable curtain 60 and housing 102 are assembled together as a unit. For example, the second fill tube 100 may be positioned in the second inflatable curtain 60, the second inflatable curtain may be folded or rolled up, and the two may be packaged in the housing 102 to form an assembly. This assembly may then be installed in the vehicle 12 by connecting the coupling portions 160 and 200 as described above. Once the fill tubes 82 and 100 are connected to each other via the coupling 150, the brackets 104 can be installed to secure the assembly in the vehicle 12.

The vehicle 12 includes a sensor 250 (shown schematically in FIGS. 1 and 2) for sensing the occurrence of an event for which inflation of the first and second inflatable curtains 50 and 60 is desired, such as a side impact to the vehicle 12 and/or a vehicle rollover. Upon sensing the occurrence of such an event, the sensor 250 provides an electrical signal over lead wires 252 to the inflator 80. The signal causes the inflator 80 to be actuated in a known manner. The inflator 80, when actuated, discharges inflation fluid under pressure into the first fill tube 82, which directs the inflation fluid into the first inflatable curtain 50. The first fill tube 80 also directs inflation fluid into the second fill tube 100 via the quick connect coupling 150.

In the event that the vehicle 12 is not equipped with the second inflatable curtain 60, such as where the vehicle is not equipped with third row seating 44, the valve assembly 170 remains in the closed condition of FIG. 3. In the closed condition, the valve assembly 170 blocks inflation fluid flow through the first coupling portion 160. This helps allow the first inflatable curtain 50 to inflate and remain pressurized.

The inflatable curtains 50 and 60 inflate under the pressure of the inflation fluid from the inflator 80. The inflatable curtains 50 and 60 inflate away from the roof 18 in a downward direction as shown in the drawings and in a downward direction with respect to the direction of forward travel of the vehicle 12 into the position illustrated in FIG. 2.

The first inflatable curtain 50, when inflated, is positioned between the side structure 16 and the first and second row seating 40 and 42, and between the side structure and any occupant of the first and second row seating. The first inflatable curtain 50, when inflated, extends from adjacent or near the A pillar 32 to adjacent or near the C pillar 36 and may cover portions of the A pillar, C pillar, and B pillar 34 of the vehicle 12.

The second inflatable curtain 60, when inflated, is positioned between the side structure 16 and the third row seating 44, and between the side structure and any occupant of the third row seating. The second inflatable curtain 60, when inflated, extends from adjacent or near the C pillar 36 to adjacent or near the D pillar 38 and may cover portions of the C pillar and D pillar of the vehicle 12.

The inflatable curtains 50 and 60, when inflated, help absorb the energy of impacts with the curtains and helps to distribute the impact energy over a large area of the curtains. The curtains 50 and 60 can help protect occupants in the event of a side impact, a vehicle rollover, or both. In such events, the inflatable curtains 50 and 60 can help prevent an occupant or a portion of an occupant from exiting the vehicle 12 through the side structure 16, e.g., the side windows 30.

Those skilled in the art will appreciate that the extent and coverage of the inflatable curtains 50 and 60 in the vehicle 12 may vary. The extent and coverage of the inflatable curtains 50 and 60 may vary depending on a variety of factors, such as the type, model, or architecture of the vehicle 12, the position of the inflatable curtains 50 and 60 in the vehicle, and the desired extent or coverage of the inflatable curtains.

To illustrate this point, a second embodiment of the present invention is illustrated in FIGS. 6 and 7. The second embodiment of the invention is similar to the first embodiment of the invention illustrated in FIGS. 1-5. Accordingly, numerals similar to those of FIGS. 1-5 will be utilized in FIGS. 6 and 7 to identify similar components, the suffix letter “a” being associated with the numerals of FIGS. 6 and 7 to avoid confusion.

The embodiment of FIGS. 6 and 7 is similar to the embodiment of FIGS. 1-5, except that the apparatus 10a of FIGS. 6 and 7 is adapted for use in a vehicle 12a having first row seating 40a and second row seating 42a. For example, as shown in FIGS. 6 and 7, the vehicle 12a may be a pickup truck. In this instance, the second row seating 42a may be offered in a four door or crew cab model of the vehicle 12, as shown in FIGS. 6 and 7.

The apparatus 10a includes a first inflatable vehicle occupant protection device in the form of a first inflatable curtain 50a and a second inflatable vehicle occupant protection device in the form of a second inflatable curtain 60a. The inflatable curtains 50a and 60a are mounted adjacent the roof 18a and side structure 16a of the vehicle 12a. The first inflatable curtain 50a is provided to help protect occupants of the first row seating 40a. The second inflatable curtain 60a is provided to help protect occupants of the second row seating 42a.

The first and second inflatable curtains 50a and 60a may be constructed with materials and in a manner similar or identical to that described above in regard to the curtains of FIGS. 1-5. An inflator 80a is connected in fluid communication with the first inflatable curtain 50a via a first fill tube 82a. In the embodiment of FIGS. 6 and 7, the first fill tube 82a extends along the length of the first inflatable curtain 50a, i.e., above the first row seating 40a. The apparatus 10a may also include a housing 90a and brackets 92a for helping to support the first inflatable curtain 50a, first fill tube 82a, and housing in the vehicle 12a. The first and second inflatable curtains 50a and 60a, inflator 80a, first fill tube 82a, housing 90a, and brackets 92a may be constructed with materials and in configurations similar or identical to those described above in regard to the embodiment of FIGS. 1-5.

As shown in FIGS. 6 and 7, the inflator 80a may be mounted at a location, such as the A pillar 32a of the vehicle 12a, and connected to a terminal end of the first fill tube 82a at or near the A pillar. Alternatively, as shown in dashed lines, the inflator 80a could be mounted to the B pillar 34a, as shown at 80a′. In this instance, the inflator 80a could be connected to the fill tube 82a via a fitting 84a, such as a “T” fitting. As a further alternative, the inflator 80a could be mounted to the vehicle 12a at a location (not shown) adjacent the intersection of the side structure 16a and roof 18a, such as a roof rail of the vehicle 12a.

The apparatus 10a also includes a second fill tube 100a for directing inflation fluid into the second inflatable curtain 60a. In the embodiment of FIGS. 6 and 7, the second fill tube 100a extends along the length of the second inflatable curtain 60a, i.e., above the second row seating 42. The apparatus 10a may also include a housing 102a and brackets 104a for helping to support the second inflatable curtain 60a, second fill tube 100a, and housing in the vehicle 12a. The second fill tube 100a, housing 102a, and brackets 104a may be constructed with materials and in configurations similar or identical to those described above in regard to the embodiment of FIGS. 1-5.

An end portion 120a of the second fill tube 10a is connected to an end portion 110a of the first fill tube 82a to provide fluid communication between the tubes. Inflation fluid may thus be directed from the first fill tube 82a into the second fill tube 100a to inflate the second inflatable curtain 60a. The connection between the first and second fill tubes 82a and 100a is established through the use of a quick connect coupling 150a that operatively couples the end portions 110a and 120a of the tubes. The quick connect coupling 150a may be similar or identical in configuration, construction, and function to that described above in regard to the first embodiment of the invention. As such, the quick connect coupling 150a of the second embodiment is also shown in FIGS. 3-5 as described above.

The first and second fill tubes 82a and 100a may be connected to each other in the manner described above after the first fill tube, first inflatable curtain 50a, inflator 80a, and housing 90a are installed in the vehicle 12a. The second fill tube 100a may be connected to the first fill tube while the second fill tube, second inflatable curtain 60a and housing 102a are assembled together as a unit. For example, the second fill tube 100a may be positioned in the second inflatable curtain 60a, the second inflatable curtain may be folded or rolled up, and the two may be packaged in the housing 102a to form an assembly. This assembly may then be installed in the vehicle 12a via the coupling 150a, as described above in regard to the embodiment of FIGS. 1-5. Once the fill tubes 82a and 100a are connected to each other via the coupling 150a, the brackets 104a can be installed to secure the assembly in the vehicle 12a.

Upon sensing the occurrence of such an event, the sensor 250a provides an electrical signal over lead wires 252a to the inflator 80a. The signal causes the inflator 80a to be actuated in a known manner. The inflator 80a, when actuated, discharges inflation fluid under pressure into the first fill tube 82a, which directs the inflation fluid into the first inflatable curtain 50a. The first fill tube 80a also directs inflation fluid into the second fill tube 100a via the quick connect coupling 150a.

The inflatable curtains 50a and 60a inflate under the pressure of the inflation fluid from the inflator 80a. The inflatable curtains 50a and 60a inflate away from the roof 18a in a downward direction as shown in the drawings and in a downward direction with respect to the direction of forward travel of the vehicle 12a into the position illustrated in FIG. 7.

The first inflatable curtain 50a, when inflated, is positioned between the side structure 16a and the first row seating 40a, and between the side structure and any occupant of the first row seating. The first inflatable curtain 50a, when inflated, extends from adjacent or near the A pillar 32a to adjacent or near the B pillar 34a and may cover portions of the A pillar and B pillar of the vehicle 12a.

The second inflatable curtain 60a, when inflated, is positioned between the side structure 16a and the second row seating 42a, and between the side structure and any occupant of the second row seating. The second inflatable curtain 60a, when inflated, extends from adjacent or near the B pillar 34a to adjacent or near the C pillar 36a and may cover portions of the B pillar and B pillar of the vehicle 12a.

Those skilled in the art will appreciate that the extent and coverage of the inflatable curtains 50a and 60a in the vehicle 12a may vary. The extent and coverage of the inflatable curtains 50a and 60a may vary depending on a variety of factors, such as the type, model, or architecture of the vehicle 12a, the position of the inflatable curtains 50a and 60a in the vehicle, and the desired extent or coverage of the inflatable curtains.

The inflatable curtains 50a and 60a, when inflated, help absorb the energy of impacts with the curtains and helps to distribute the impact energy over a large area of the curtains. The curtains 50a and 60a can help protect occupants in the event of a side impact, a vehicle rollover, or both. In such events, the inflatable curtains 50a and 60a can help prevent an occupant or a portion of an occupant from exiting the vehicle 12a through the side structure 16a, e.g., the side windows 30a.

In the event that the vehicle 12a is not equipped with the second inflatable curtain 60a, such as where the first inflatable curtain is installed in a vehicle (not shown) having a single row seating, e.g., a single cab pickup truck, the valve assembly of the coupling 150a blocks inflation fluid flow, which helps allow the first inflatable curtain 50a to inflate and remain pressurized.

From the above description of the invention, those skilled in the art will perceive improvements, changes and modifications. Such improvements, changes and modifications within the skill of the art are intended to be covered by the appended claims.

Having described the invention, the following is claimed:

1. An apparatus for helping to protect an occupant of a vehicle, said apparatus comprising:
a first inflatable vehicle occupant protection device inflatable to protect occupants of a first row of vehicle seating;
a first fill tube for delivering inflation fluid to said first inflatable vehicle occupant protection device;
a second inflatable vehicle occupant protection device inflatable to protect an occupant of a row of vehicle seating different than said first row of vehicle seating;
a second fill tube for delivering inflation fluid to said second inflatable vehicle occupant protection device; and
a quick connect coupling for connecting said second fill tube to said first fill tube to direct inflation fluid from said first fill tube into said second fill tube.

2. The apparatus recited in claim 1, wherein said quick connect coupling has a first portion associated with an end portion of said first fill tube and a second portion associated with an end portion of said second fill tube, said apparatus being free from any other means for connecting said second end portions of said first and second fill tubes.

3. The apparatus recited in claim 2, wherein said first and second portions of said quick connect coupling are fixed to said first and second end portions, respectively.

4. The apparatus recited in claim 1, wherein said quick connect coupling comprises:
locking means operable to maintain the connection between said first and second fill tubes; and
valve means openable upon said first and second fill tubes being connected by said quick connect coupling, said valve means when opened providing fluid communication between said first and second fill tubes.

5. The apparatus recited in claim 1, wherein said quick connect coupling includes a first coupling portion associated with said first fill tube and a second coupling portion associated with said second fill tube, said second coupling portion being connectable with said first coupling portion to provide fluid communication between said first fill tube and said second fill tube.

6. The apparatus recited in claim 5, wherein said first coupling portion comprises a valve assembly for blocking inflation fluid flow through said first coupling portion when said second coupling portion is disconnected from said first coupling portion.

7. The apparatus recited in claim 6, wherein said second coupling portion when connected with said first coupling portion opens said valve assembly.

8. The apparatus recited in claim 5, wherein said first coupling portion is associated with a terminal end portion of said first fill tube.

9. The apparatus recited in claim 5, wherein said first coupling portion comprises a first sleeve and said second coupling portion comprises a second sleeve insertable into said first sleeve, said second sleeve comprising a locking member for engaging with a locking member receiving portion of said first sleeve.

10. The apparatus recited in claim 9, wherein said locking member comprises a latch member and said locking member receiving portion comprises an aperture in said first sleeve, said latch member being spring biased into said aperture when said second sleeve is received in said first sleeve.

11. The apparatus recited in claim 10, wherein said latch member has a spherical configuration and said aperture has a circular configuration with a diameter greater than a diameter of said latch member, said spherical latch member being spring biased into said circular aperture when said second sleeve is received in said first sleeve.

12. The apparatus recited in claim 1, further comprising an inflator actuatable to provide inflation fluid to said first fill tube.

13. The apparatus recited in claim 1, wherein said end portion of said first fill tube protrudes from said first inflatable vehicle occupant protection device near a rear edge of said inflatable vehicle occupant protection device.

14. The apparatus recited in claim 1, further comprising a closure member connectable with said open end portion of said first fill tube to block inflation fluid flow through said end portion of said first fill tube.

15. The apparatus recited in claim 1, wherein said first inflatable vehicle occupant protection device is inflatable away from a roof of the vehicle to a position between a side structure of the vehicle and the first row seating, said second inflatable vehicle occupant protection device being inflatable away from the roof to a position between the side structure and the second row seating.

16. The apparatus recited in claim 1, wherein said first inflatable vehicle occupant protection device is inflatable away from a roof of the vehicle to a position between a side structure of the vehicle and a first row of vehicle seating, said second inflatable vehicle occupant protection device being inflatable away from the roof to a position between the side structure and a second row of vehicle seating.

17. The apparatus recited in claim 1, wherein said first inflatable vehicle occupant protection device is inflatable away from a roof of the vehicle to a position between a side structure of the vehicle and first and second rows of vehicle seating, said second inflatable vehicle occupant protection device being inflatable away from the roof to a position between the side structure and a third row of vehicle seating.

18. An apparatus for helping to protect an occupant of a vehicle that has first row seating and second row seating, said apparatus comprising:
a first inflatable vehicle occupant protection device inflatable to protect occupants of the first row seating;
a first fill tube for delivering inflation fluid to said first inflatable vehicle occupant protection device; and
a quick connect coupling secured to said first fill tube, said quick connect coupling being for receiving a second fill tube and providing fluid communication between said first and second fill tubes, said quick connect coupling comprising:
locking means operable to connect said second fill tube to said first fill tube when said second fill tube is received in said quick connect coupling; and
valve means openable upon said second fill tube being received in said quick connect coupling, said valve means when opened providing fluid communication between said first and second fill tubes.

19. The apparatus recited in claim 18, wherein said valve means blocks inflation fluid flow through said quick connect coupling when disconnected from said second fill tube.

20. An apparatus for helping to protect an occupant of a vehicle that has first row seating, second row seating, and third row seating, said apparatus comprising:
a first inflatable vehicle occupant protection device inflatable to protect occupants of the first row seating and the second row seating;
a first fill tube for delivering inflation fluid to said first inflatable vehicle occupant protection device;
a second inflatable vehicle occupant protection device inflatable to protect an occupant of the third row seating;
a second fill tube for delivering inflation fluid to said second inflatable vehicle occupant protection device; and
a quick connect coupling for connecting said second fill tube to said first fill tube to direct inflation fluid from said first fill tube into said second fill tube.
